(19) United States
(12) Patent Application Publication
(10) Pub. No.: US 2016/0125398 A1
(43) Pub. Date: May 5, 2016

(54) SECURELY AND INSTANTLY CONVERTING DIGITAL WALLET VALUE TO PHYSICAL GOLD BULLION

(71) Applicant: BitGold IP Holdings Corp., TORONTO (CA)

(72) Inventors: ROY SEBAG, TORONTO (CA); JOSHUA D. CRUMB, VANCOUVER (CA)

(21) Appl. No.: 14/925,937

(22) Filed: Oct. 28, 2015

Related U.S. Application Data
(60) Provisional application No. 62/072,409, filed on Oct. 29, 2014.

(51) Int. Cl. G06Q 20/38; G06Q 30/06; G06Q 20/06; G06Q 20/36; G06Q 20/10

(52) U.S. Cl. CPC G06Q 20/381; G06Q 20/36; G06Q 20/10; G06Q 20/0655; G06Q 30/0617

(57) ABSTRACT

Disclosed is a system related to a software platform that implements an algorithm for facilitating an instant and secure digital value transaction within a network. The digital wallet value of user(s) is converted into a virtual currency and the consolidated pricing feed of the gold bullion counterparties are computed. Further, the converted virtual currency is matched with the consolidated pricing feed of the gold bullion counterparties and based on the matching criteria an invoice can be generated for the user to purchase the gold. The generated invoice is further confirmed or secured by performing multiple signatures from different stake holders involved in the digital value transaction. Different stakeholders involved in the transaction include a server implementing the algorithm, users interested in digital value transaction, and the network through which the transaction happens. The completed digital value transaction is published on the communication device for the user to purchase gold.

### CROSS-REFERENCE TO RELATED APPLICATIONS

The present application claims priority benefit from U.S. Provisional Patent Application No. 62/072,409, entitled “SECURELY AND INSTANTLY CONVERTING DIGITAL WALLET VALUE TO PHYSICAL GOLD BULLION”, filed Oct. 29, 2014 (docket number 3023-002-02), co-pending at the time of filing; which, to the extent not inconsistent with the description herein, is incorporated by reference.

### SUMMARY

The present disclosure relates to converting digital wallet value to gold within a network and, more particularly, to securely converting digital wallet value to gold within the network by using multiple signatures for completing a digital value transaction.

Recent innovations in decentralized payment ledger technologies utilizing cryptography and a method for distributed consensus for solving the double-spend problem have paved the way for the Internet to revolutionize money, assets, and anything of value. As with information, data, and knowledge, the Internet provides superior architecture for the rapid transfer, distribution, discovery, and speculation in things of value. Because the Internet is digital by nature it is inherently susceptible to remote intrusion by cybercriminals or hackers. Complicating this inherent risk are the legal and logistical difficulties in enforcing cyber-crime laws or bringing a case against hackers who often reside in jurisdictions that are far from the locations they target. As the Internet has grown to reach 90% of the world's population, so has cybercrime. There are no real-world solutions for preventing cybercrime that are hack-proof. These unstoppable intrusions have had a relatively minimal effect on society thus far. That is because thus far, the Internet was primarily for distributing data, knowledge, or information. While these three uses are valuable, there is generally a buffer between the value of the data and one's ability to monetize that value. The continued transformation of the Internet to accommodate transfers of value will most likely result in continued intrusions. However, these intrusions differ from historical intrusions as the attackers are able to cause real-world damage by depleting real-world values without real-world ramifications from the law. There is a need for technology that can rapidly convert digital assets that are at risk of cyber-intrusion into a neutral, stable, real-world asset that can be insured and defended utilizing real-world resources. Further, the technology may rapidly secure digital values by storing them as gold for the benefit of a customer in vaults of their choosing.

According to an embodiment, a software platform implements an algorithm in a system to facilitate rapid security for a digital value (e.g., crypto-currency) transaction. The digital value transaction includes computing consolidated pricing feeds for one or more counterparties that deal in gold. Further, the algorithm determines the funds required to purchase gold from one or more counterparties and converts the digital wallet value or digital asset associated with one or more users to a necessary value. Further, the algorithm matches the consolidated pricing feeds with the necessary value associated with one or more users and enables the user to decide about purchasing gold from the counterparty for the specified amount. Further, the algorithm receives confirmation from one or more users to purchase gold from the counterparty based on a matching criteria determined by matching the consolidated pricing feeds with the necessary value associated with one or more users. Further, the system allows the user to purchase gold bullion from the counterparty after the digital value transaction is completed and the purchased gold can be stored in an offline cold-storage.

Embodiments of the present disclosure address some of the shortcomings of using digital currencies. The various embodiments of the disclosure can be implemented to improve the technical fields of securing digital funds, data processing, and user experience. Therefore, the various described embodiments of the disclosure and their associated benefits amount to significantly more than an abstract idea.

Other objects and advantages of the embodiments herein will become readily apparent from the following detailed description taken in conjunction with the accompanying drawings.

### BRIEF DESCRIPTION OF THE DRAWING(S)

FIG. 1 is a block diagram of a system for providing security for a digital value transaction, according to an embodiment.

FIG. 2 illustrates a system overview of components used for implementing security for the digital value transaction, according to an embodiment.

FIG. 3 is a flow-chart that explains the process of purchasing gold by securely converting the digital wallet value to a necessary value, according to an embodiment.

FIG. 4 is a flow-chart for a process of using multiple signature confirmation for implementing a secure digital value transaction, according to an embodiment.

FIG. 5 illustrates a flow-chart for a process for facilitating security for a digital value transaction, according to an embodiment.

### FIGURES

### Reference Numerals

100—System for implementing a secure digital value transaction
101—A server used for processing the initiated digital value transaction
102—User electronic device
102a, 102b, 102c, 102d—Users involved in the digital value transaction
connected through various communicating devices
103—Gold counterparties
104—An Internet through which the digital value transaction is performed
200—System components used for implementing the secure digital value transaction
201—User interface module used for receiving user inputs and displaying digital value transaction
202—Price feed consolidating module used for computing a consolidated pricing value for gold counterparty
203—Digital value conversion module used for converting the digital wallet value or digital asset to a necessary value associated with the user
204—Payment processor module used for generating invoice for the initiated digital value transaction
205—Storage module used for storing the converted digital wallet value associated with the user and the gold market value
206—Controlling module for performing additional activities

### DETAILED DESCRIPTION

In the following detailed description, a reference is made to the accompanying drawings that form a part hereof, and in which some embodiments that may be practiced are shown by way of illustration. Those skilled in the art will understand, in light of the present disclosure, that many modifications and changes may be made without departing from the scope of the present disclosure. The following detailed description is therefore not to be taken in a limiting sense.

Using the disclosed embodiments of a method and system for securely and quickly converting digital wallet value to gold (physical gold bullion), the security of receiving using digital currency is greatly enhanced. Therefore, the disclosed embodiments of a method and system securely and quickly converting digital wallet value to gold provides a technical solution to the technical problem of unsecured and risk-laden digital wallet systems and transactions.

The result is a much more secure method and system for utilizing digital wallets that thereby serves to bolster confidence in the security of using purely digital currency. This, in turn, can result in less human and processor resources being dedicated to securing digital wallets, i.e., less memory, processing, and bandwidth resources being used for securing the funds within electronic wallets.

The disclosed method and system for securely and quickly converting digital wallet value to gold does not encompass, embody, or preclude other forms of innovation in the area of converting digital wallet values to gold. In addition, the disclosed method and system for securely and quickly converting digital wallet value to gold is not related to any fundamental economic practice, fundamental data processing practice, mental steps, or pen and paper based solutions, and is, in fact, directed to providing solutions to the relatively new problems associated with electronic commerce systems. Consequently, the disclosed method and system for securely and quickly converting digital wallet value to gold is not directed to, does not encompass, and is not merely, an abstract idea or concept.

A digital value transaction involves the use of computer networks such as the Internet and digital stored values for storing and transmitting digital wallet value or digital assets for purchasing gold from one or more counterparties.

A consolidated pricing feed is computed by consolidating a bid and ask-spread price that is determined based on a destination vault location of one or more gold counterparties.

In an embodiment, a digital wallet application is installed on the electronic device of the user and the digital wallet application contains digital assets accumulated for the user.

In an embodiment, the digital assets can be quickly converted into a virtual currency which can be used for purchasing gold through counterparties that sell gold.

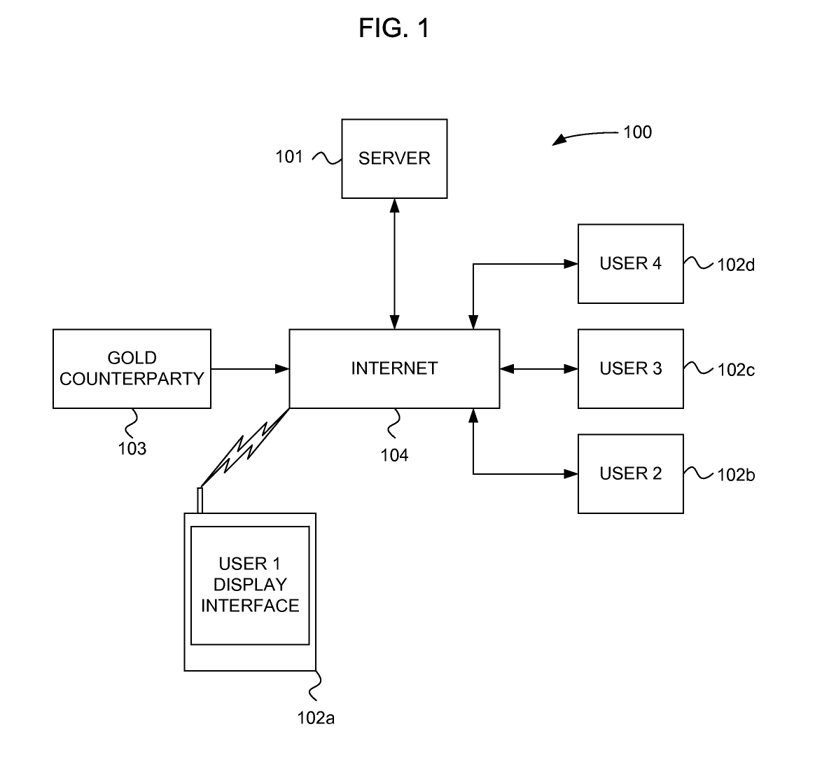

FIG. 1 is a block diagram of a system for providing security for a digital value transaction, according to an embodiment. The system 100 includes a server 101 connected to Internet 104 for processing a digital value transaction. In an embodiment, the server 101 receives information from the users through various user electronic devices 102 for initiating a digital value transaction. The user electronic device 102 can include, but is not limited to, a computer, a mobile phone, a web browser interface or the like. Further, the information received from the user includes but is not limited to a destination location of the vault, the amount to be raised by converting the digital asset to the virtual currency, the projected cost, or the like. Based on the information received from the user electronic device 102, the server 101 automatically converts the specified digital wallet value or asset into a virtual currency that can be used in trading gold with one or more gold counterparties 103. The virtual currency can be in the form of bitcoins, automated clearing house (ACH), social media credits, coupons or the like. In an embodiment, the converted virtual currency is stored in the vault location as specified by the user. In an embodiment, the user can choose a third-party Vault Provider such Brinks® or G4s® by providing the user account for implementing secured conversions and digital value transactions through the Vault Providers.

In an embodiment, the digital wallet asset and the converted virtual currency regulatory risks can be reduced by using third-party platforms that provide tax compliance and other regulatory services. For example, the regulatory risks can adhere to anti-money laundering (AML) or Know-Your Customer (KYC) guidelines.

The digital value transaction is performed through the Internet 104 and the transaction is processed on the server 101. While processing the transaction on the server 101, the converted virtual currency is matched with the consolidated pricing feed determined for one or more gold bullion counterparties 103. In an embodiment, based on the user's choice, if the converted virtual currency is greater than or equivalent to the consolidated pricing feed determined for the gold bullion counterparty, then the server 101 sends a confirmation request to the user through the user electronic device 102 for purchasing gold for the specified virtual currency. The user then confirms the request to purchase gold by performing a digital signature for the confirmation request. Upon receiving the confirmation from the user, the server 101 generates an invoice for purchasing gold from a gold bullion counterparty for the specified virtual currency. Further, the generated invoice is sent to the user for the user to confirm the transaction by performing a digital signature. The confirmed invoice is sent to the server 101 and the server 101 confirms the invoice by verifying the invoice and digital signing the invoice. Finally, the server 101 publishes the invoice on the user's user electronic device 102 after the network digitally signs the invoice. Based on the final confirmation, the user can buy gold from the counterparty and the purchased gold can be safely deposited in the offline cold-storage.

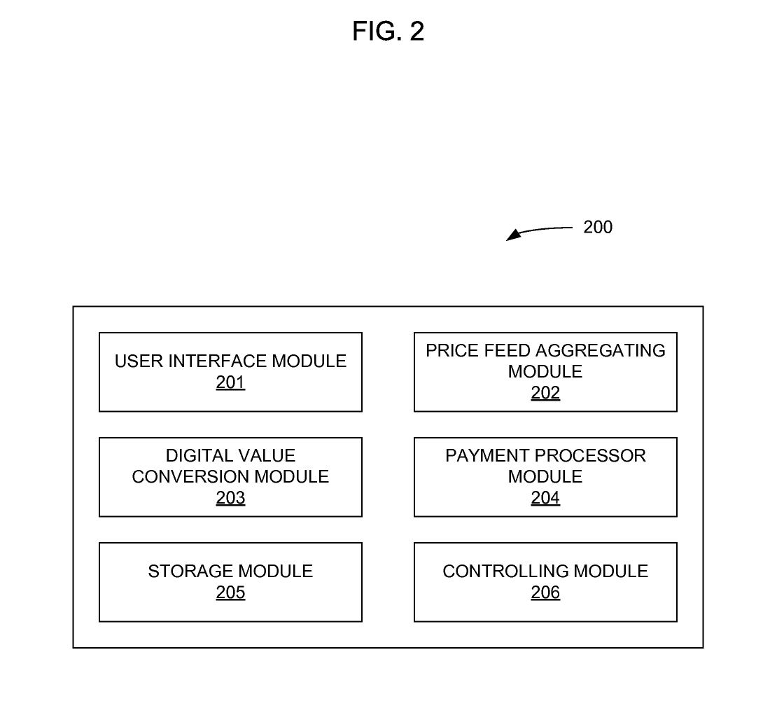

FIG. 2 illustrates a system including components used for implementing security for the digital value transaction, according to an embodiment. The system overview of components includes the following modules: a User Interface module 201, a Price Feed Aggregating module 202, a Digital Value Conversion module 203, a Payment Processor module 204, a Storage module 205, and a Controlling module 206. In an embodiment, the User Interface module 201 is configured to provide a user interface for receiving a user's input and providing information and notifications regarding the digital value transaction to the user. In an embodiment, the Price Feed Aggregating module 202 is configured to determine the consolidated pricing feed for one or more gold bullion counterparties within the network. In an embodiment, the Digital Value Conversion module 203 is configured to convert the digital wallet value of the user to a virtual currency. In an embodiment, the Payment Processor module 204 is configured to generate an invoice when the virtual currency matches with the fund amount required for buying gold from one or more counterparties within the network and to complete a purchase of gold from a gold bullion counterparty. In an embodiment, the Storage module 205 is configured to store the converted virtual currency of one or more users and the generated invoice in the server 101. In an embodiment, free gold storage vaults can be operated by third-party Vault Providers such as BRINKS® or G4s®. The gold storage vaults can be insured by third-party insurance companies such as Lloyds of London.

In an embodiment, the Controlling module 206 is configured to perform additional activities such as transferring data or information from one module to another module, matching the consolidated pricing feed with the virtual currency determined for the user, or the like.

According to an embodiment a computing system method for facilitating security for a digital value transaction includes receiving, with the user interface module 201 of a computing system, input from a user initiating a transaction to convert digital currency to gold. The method further includes receiving, with the price feed aggregating module 202, a price of gold associated with a counterparty that deals in gold. The method further includes determining, with the digital value conversion module 203 of the computing system, an amount of digital currency to be converted to a quantity of gold based on the price of gold, the amount digital currency being stored in a digital wallet associated with a user, the quantity of gold being based on the amount of digital currency and the price of gold. The method includes receiving, with the user interface module 201, a confirmation from the user to convert the amount of digital currency to the quantity of gold, and converting, with the payment processor module 204, the amount of digital currency to the quantity of gold by transferring the amount of digital currency from the digital wallet to the counterparty.

According to an embodiment, receiving the price of gold includes receiving, with the price feed aggregating module 202, a plurality of prices of gold, each price being associated with a respective counterparty that deals in gold. The method can include selecting, with the price feed aggregating module 202, the price of gold from the plurality of prices of gold. Alternatively, the method can include providing, with the user interface module 201, the plurality of prices of gold to the user and receiving, with the user interface module, a selection of the price of gold from the plurality of prices of gold. Alternatively, the method can include receiving, with the user interface module 201, a selection from the user indicating the one or more vaults and receiving the plurality of prices based on a geographical location of the one or more vaults.

According to an embodiment, determining the amount of digital currency includes receiving, with the user interface module 201, a selection from the user indicating the amount of digital currency to be converted to the quantity of gold.

According to an embodiment, determining the amount of digital currency includes receiving, with the user interface module 201, a selection from the user indicating the quantity of gold.

According to an embodiment, the method can further include providing with the user interface module 201, an invoice to the user indicating that the amount of digital currency has been converted to the quantity of gold. According to an embodiment, the price of gold is given in the digital currency. According to an embodiment, receiving confirmation includes receiving a digital signature from the user. According to an embodiment, receiving confirmation includes receiving multiple digital signatures from the user.

According to an embodiment, the amount of digital currency is all of the digital currency associated with the digital wallet. Alternatively, the amount of digital currency can be only a portion of the total digital currency associated with the digital wallet.

According to an embodiment, the method can include receiving, with the user interface module 201, a selection from the user indicating the quantity of gold, wherein determining the amount of digital currency is based on the selection of the quantity of gold and the price of gold.

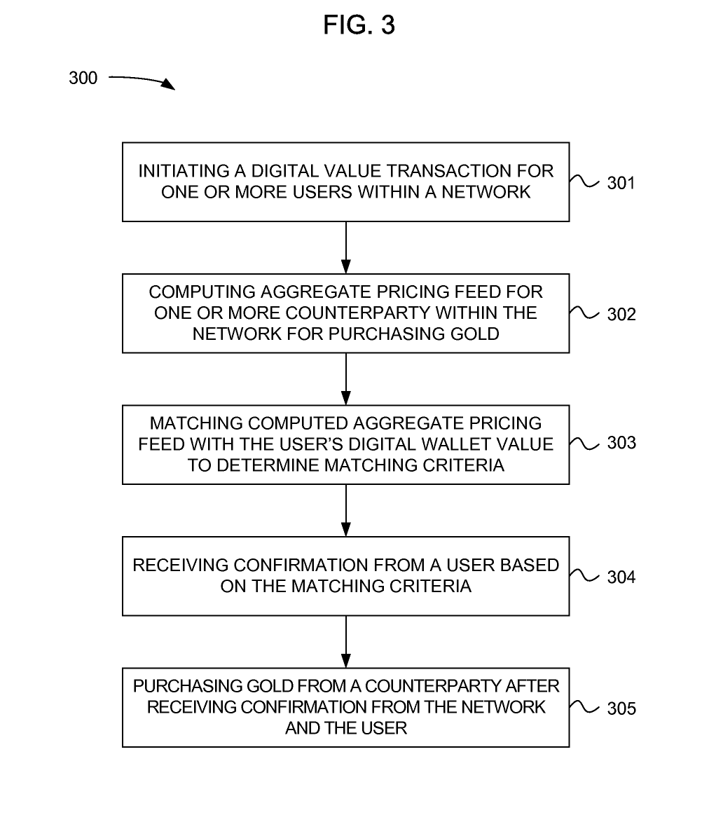

FIG. 3 is a flow-chart of a process for purchasing gold by securely converting a digital wallet value or digital asset to a virtual currency or a necessary value to, according to an embodiment. Initially, at step 301 a digital value transaction is initiated for one or more users within the network by using the user's account. At step 302, the consolidated pricing feed is computed for one or more gold bullion counterparties. In an embodiment, the Price Feed Consolidating module is configured to compute the consolidated pricing feed for one or more gold bullion counterparties. At step 303, the consolidated pricing feed of the gold bullion counterparty is matched with the converted virtual currency of one or more users. In an embodiment, the controlling module is configured to match the pricing feed of the gold bullion counterparties with the converted virtual currency. At step 304, if the matching criteria between the converted virtual currency and the consolidated pricing feed of the gold bullion counterparty are greater than or equivalent to the pricing feed of the gold bullion counterparty selected by the user, then a confirmation request is sent to the user from the server. In an embodiment, the Controlling module is configured to match the converted virtual currency with the consolidated pricing feed of the gold bullion counterparty selected by the user. At step 305, the user purchases the gold after receiving confirmation from the server and is published on the network.

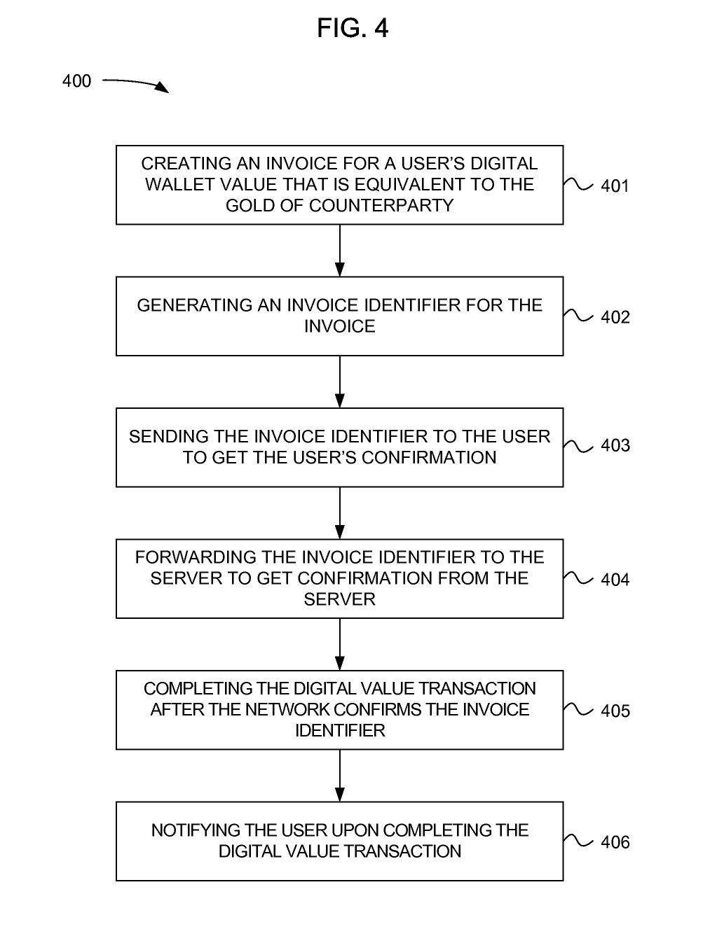

FIG. 4 illustrates a flow-chart for a process of using multiple signature confirmation for implementing a secure digital value transaction, according to an embodiment. Initially, at step 401, an invoice is created based on matching criteria determined after matching a converted digital wallet value with the consolidated pricing feed value. In an embodiment, the invoice is created if the matching criteria depicts that the converted digital wallet value is greater than or equivalent to the consolidated pricing feed value of the selected counterparty. In an embodiment, the Controlling module is configured to determine the matching criteria for the converted digital wallet value with the consolidated price feed value of the selected counterparty. At step 402, an invoice identifier is generated for the created invoice. In an embodiment, the Payment Processor module is configured to generate an invoice identifier for the invoice. In an embodiment, the invoice identifier includes the following information: a digital wallet address, a digital wallet value, a time-period associated with invoice identifier or the like. At step 403, the generated invoice identifier is sent to the user to receive the user's confirmation. In an embodiment, the Controlling module is configured to send the generated invoice identifier to the user. At step 404, the invoice identifier is confirmed by the user and is sent to the server for confirmation from the server. In an embodiment, the Controlling module is configured to send the invoice identifier to the server for getting confirmation from the server. At step 405, the initiated digital value transaction status is changed to completion after the network confirms the invoice identifier. In an embodiment, the Controlling module is configured to change the initiated digital value transaction status to completion after the network confirms the digital value transaction. At step 406, the completed digital value transaction is published or notified to the user. In an embodiment, the Controlling module is configured to publish or notify the completed digital value transaction to the user. Further, the user can continue to purchase gold based on the completed digital value transaction.

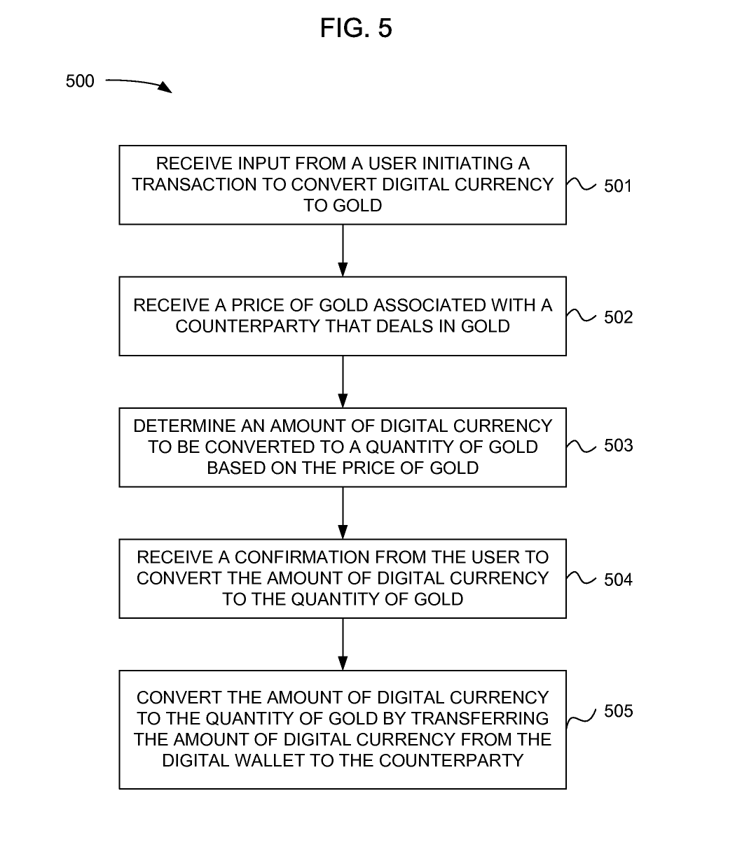

FIG. 5 illustrates a flow-chart for a method 500 for facilitating security for a digital value transaction, according to an embodiment. Initially, at step 501, a user interface module receives input from a user initiating a transaction to convert digital currency to gold. At step 502, a price feed aggregating module receives a price of gold associated with a counterparty that deals in gold. At step 503, a digital value conversion module determines an amount of digital currency to be converted to a quantity of gold based on the price of gold. At step 504, the user interface module receives a confirmation from the user to convert the amount of digital currency to the quantity of gold. At step 505, a payment processor module converts the amount of digital currency to the quantity of gold by transferring the amount of digital currency from the digital wallet to the counterparty.

According to an embodiment, a system for facilitating security for a digital value transaction includes at least one processor and at least one memory coupled to the at least one processor, the at least one memory having stored therein instructions which, when executed by any set of the one or more processors, perform a process. The process includes receiving, with a user interface module of a computing system, input from a user initiating a transaction to convert digital currency to gold, receiving, with a price feed aggregating module of the computing system, a price of gold associated with a counterparty that deals in gold, and determining, with a digital value conversion module of the computing system, an amount of digital currency to be converted to a quantity of gold based on the price of gold, the amount digital currency being stored in a digital wallet associated with a user, the quantity of gold being based on the amount of digital currency and the price of gold. The process further includes receiving, with the user interface module of the computing system, a confirmation from the user to convert the amount of digital currency to the quantity of gold, and converting, with a payment processor module, the amount of digital currency to the quantity of gold by transferring the amount of digital currency from the digital wallet to the counterparty.

According to an embodiment, a non-transitory computer readable medium having a plurality of computer-executable instructions which, when executed by a processor, perform a method for security of a digital value transaction. The instructions include a user interface module configured to receive input from a user initiating a transaction to convert digital currency to gold and a price feed aggregating module configured to gather a plurality of prices of gold each associated with a respective counterparty that deals in gold. The instructions further include a digital value conversion module configured to determine an amount of digital currency to be converted to a quantity of gold based on at least one of the prices of gold, the user interface module being configured to receive a confirmation from the user to convert the amount of digital currency to the quantity of gold and a payment processor module configured to convert the amount of digital currency to the quantity of gold by transferring the amount of digital currency to a selected counterparty.

According to an embodiment, a method enables a user to purchase gold with virtual currency. The method includes receiving in a server a request from a user electronic device to initiate a transaction, receiving in the server a plurality of prices for gold from a plurality of counter parties, and transmitting from the server to the user electronic device the plurality of prices for gold. The method further includes receiving at the server a request from the user electronic device to purchase with virtual currency a quantity of gold from a selected one of the counterparties and transmitting from the server a purchase request to the selected counterparty for the quantity of gold. The method can include receiving at the server a designation of a selected gold repository and transmitting from the server to the selected counterparty a request to store the quantity of gold at the selected gold repository. The method can further include receiving in the server a user identification corresponding to a user of the electronic device, calculating in the server an amount of virtual currency available to the user, and transmitting the purchase request to the selected counterparty if the amount of virtual currency available to the user is sufficient to purchase the quantity of gold. The method can further include checking an amount of virtual currency available to a user of the user electronic device, and, if the amount of virtual currency available to the user is sufficient to buy the gold, transmitting from the processor a request to the selected counter-party to purchase the gold.

According to an embodiment a system includes a server. The server includes a computer readable medium and a processor. The computer readable medium is configured to store software instructions. The processor is configured to execute the software instructions to perform a method for enabling a user to convert virtual currency to gold. The method includes receiving at the processor a plurality of prices of gold from a plurality of counter parties, storing in the computer readable medium the plurality of prices of gold, transmitting to a user electronic device the plurality of prices of gold via the Internet, and receiving in the processor a request from the user electronic device via the Internet to purchase gold from a selected one of the counter-parties.

According to an embodiment, a computing system method for facilitating security for a digital value transaction includes computing consolidated pricing feeds for at least one counterparty dealing with gold, determining a fund required to purchase an quantity of gold from at least one counterparty, and converting the digital wallet value associated with at least one user to a necessary value. The method further includes matching the consolidated pricing feeds that are computed with the necessary value associated with the at least one user for purchasing the quantity of gold from the at least one counterparty, receiving confirmation from the at least one user to purchase the quantity of gold from the at least one counterparty based on a matching criteria determined after matching the consolidated pricing feeds with the necessary value associated with the at least one user, and purchasing the quantity of gold from the at least one counterparty after receiving confirmation from the at least one user. According to an embodiment, the method can further include consolidating and reconciling net daily conversions of value and settlement of gold purchases, displaying a status of at least one the digital value transaction that is stored as a record in a memory storage, and eliminating the record after the at least one digital value transaction status is completed. The method can also include monitoring at least one the digital value transaction associated with at least one user, which can include checking the gold delivery status to a vault location associated with the at least one user and checking various vault locations associated with the at least one user. The method further includes tracking at least one the digital value transaction associated with the at least one user. The tracking at least one the digital value transaction can include withdrawing a gold delivery from a vault location associated with the at least one user after accepting a request sent by the at least one user to withdraw the gold delivery and selling a gold from the vault location associated with the at least one user after accepting a request sent by the at least one user to sell the gold.

According to an embodiment, a system for facilitating security for a digital value transaction includes at least one processor and at least one memory coupled to the at least one processor, the at least one memory having stored therein instructions which, when executed by any set of the one or more processors, perform a process. The process includes computing consolidated pricing feeds for at least one counterparty dealing with gold, determining a fund required to purchase a quantity of gold from at least one counterparty, converting the digital wallet value associated with at least one user to a necessary value, and matching the consolidated pricing feeds that are computed with the necessary value associated with the at least one user for purchasing the quantity of gold from the at least one counterparty. The process further includes receiving confirmation from the at least one user to purchase the quantity of gold from the at least one counterparty based on a matching criteria determined after matching the consolidated pricing feeds with the necessary value associated with the at least one user and purchasing the quantity of gold from the at least one counterparty after receiving confirmation from the at least one user.

According to an embodiment, a system for facilitating security for a digital value transaction within a network includes at least one processor and at least one memory coupled to the at least one processor, the at least one memory having stored therein instructions which, when executed by any set of the one or more processors, perform a process. The process includes creating an invoice for a specific digital wallet value equivalent to a quantity of gold to be purchased by at least one user, generating an invoice identifier for the created invoice, wherein the invoice identifier includes a digital wallet address, a digital wallet value, and a time-period associated with the invoice identifier, sending the invoice identifier to the at least one user, receiving a digital signature from the at least one user confirming the invoice identifier using the web interface device, and forwarding the invoice identifier to a server after receiving the digital signature from the at least one user. The process further includes publishing the invoice identifier on the network after the server receives the invoice identifier, confirming the invoice identifier, completing the digital value transaction after confirming the invoice identifier, and sending a notification to a web interface device of the user indicating that the digital value transaction is completed.

According to an embodiment, a non-transitory computer readable medium has a plurality of computer-executable instructions which, when executed by a processor, perform a method for security for a digital value transaction. The instructions include a price feed aggregator module configured to compute consolidated pricing feeds for at least one counterparty dealing with gold, and a digital value conversion module configured to determine a fund required to purchase a quantity of gold from at least one counterparty and to convert the digital wallet value associated with at least one user to a necessary value, and to match the consolidated pricing feeds that are computed with the necessary value associated with the at least one user for purchasing the quantity of gold from the at least one counterparty. The instructions further include a user interface module configured to receive confirmation from the at least one user to purchase the quantity of gold from the at least one counterparty based on a matching criteria and payment processor module configured to purchase the quantity of gold from the at least one counterparty after receiving confirmation from the at least one user.

According to an embodiment a computer readable medium can include a plurality of separate memory devices. The memory devices can be in single location or in a plurality of different locations. Likewise, the processor can include multiple distinct processor units in a single location or in a plurality of separate locations.

The foregoing description of particular embodiments will so fully reveal the general nature of the embodiments herein that others can, by applying current knowledge, readily modify and/or adapt for various applications such embodiments without departing from the generic concept, and, therefore, such adaptations and modifications fall within the scope of the present disclosure. It is to be understood that the phraseology or terminology employed herein is for the purpose of description and not of limitation.

What is claimed is:

1. A computing system method for facilitating security for a digital value transaction, comprising:
receiving, with a user interface module of a computing system, input from a user initiating a transaction to convert digital currency to gold;
receiving, with a price feed aggregating module of the computing system, a price of gold associated with a counterparty that deals in gold;
determining, with a digital value conversion module of the computing system, an amount of digital currency to be converted to a quantity of gold based on the price of gold, the amount digital currency being stored in a digital wallet associated with a user, the quantity of gold being based on the amount of digital currency and the price of gold;
receiving, with the user interface module of the computing system, a confirmation from the user to convert the amount of digital currency to the quantity of gold; and
converting, with a payment processor module, the amount of digital currency to the quantity of gold by transferring the amount of digital currency from the digital wallet to the counterparty.

2. The method of claim 1, wherein receiving the price of gold includes receiving, with the price feed aggregating module, a plurality of prices of gold, each price being associated with a respective counterparty that deals in gold.

3. The method of claim 2, comprising selecting, with the price feed aggregating module, the price of gold from the plurality of prices of gold.

4. The method of claim 2, comprising:
providing, with the user interface module, the plurality of prices of gold to the user; and
receiving, with the user interface module, a selection of the price of gold from the plurality of prices of gold.

5. The method of claim 2, comprising receiving, with the user interface module, a selection from the user indicating the one or more vaults.

6. The method of claim 5, comprising receiving the plurality of prices based on a geographical location of the one or more vaults.

7. The method of claim 1, wherein determining the amount of digital currency includes receiving, with the user interface module, a selection from the user indicating the amount of digital currency to be converted to the quantity of gold.

8. The method of claim 1, wherein determining the amount of digital currency includes receiving, with the user interface module, a selection from the user indicating the quantity of gold.

9. The method of claim 1, comprising providing, with the user interface module, an invoice to the user indicating that the amount of digital currency has been converted to the quantity of gold.

10. The method of claim 1, wherein the price of gold is in the digital currency.

11. The method of claim 1, wherein receiving confirmation includes receiving a digital signature from the user.

12. The method of claim 1, wherein receiving confirmation includes receiving multiple digital signatures from the user.

13. The method of claim 1, wherein the amount of digital currency is all of the digital currency associated with the digital wallet.

14. The method of claim 1, comprising receiving, with the user interface module, a selection from the user indicating the quantity of gold, wherein determining the amount of digital currency is based on the selection of the quantity of gold and the price of gold.

15. A system for facilitating security for a digital value transaction, the system comprising:
at least one processor; and
at least one memory coupled to the at least one processor, the at least one memory having stored therein instructions which, when executed by any set of the one or more processors, perform a process including:
receiving, with a user interface module of a computing system, input from a user initiating a transaction to convert digital currency to gold;
receiving, with a price feed aggregating module of the computing system, a price of gold associated with a counterparty that deals in gold;
determining, with a digital value conversion module of the computing system, an amount of digital currency to be converted to a quantity of gold based on the price of gold, the amount digital currency being stored in a digital wallet associated with a user, the quantity of gold being based on the amount of digital currency and the price of gold;
receiving, with the user interface module of the computing system, a confirmation from the user to convert the amount of digital currency to the quantity of gold; and
converting, with a payment processor module, the amount of digital currency to the quantity of gold by transferring the amount of digital currency from the digital wallet to the counterparty.

16. The system of claim 15, wherein receiving the price of gold includes receiving, with the price feed aggregating module, a plurality of prices of gold, each price being associated with a respective counterparty that deals in gold.

17. The system of claim 16, wherein the process includes selecting, with the price feed aggregating module, the price of gold from the plurality of prices of gold.

18. The system of claim 16, wherein the process includes:
providing, with the user interface module, the plurality of prices of gold to the user; and
receiving, with the user interface module, a selection of the price of gold from the plurality of prices of gold.

19. The system of claim 16, wherein the process includes receiving, with the user interface module, a selection from the user indicating the one or more vaults.

20. The system of claim 19, wherein the process includes receiving the plurality of prices based on a geographical location of the one or more vaults.

21. The system of claim 15, wherein determining the amount of digital currency includes receiving, with the user interface module, a selection from the user indicating the amount of digital currency to be converted to the quantity of gold.

22. The system of claim 15, wherein determining the amount of digital currency includes receiving, with the user interface module, a selection from the user indicating the quantity of gold.

23. The system of claim 15, wherein the process includes providing, with the user interface module, an invoice to the user indicating that the amount of digital currency has been converted to the quantity of gold.

24. The system of claim 15, wherein the price of gold is in the digital currency.

25. The system of claim 15, wherein receiving confirmation includes receiving a digital signature from the user.

26. The system of claim 15, wherein receiving confirmation includes receiving multiple digital signatures from the user.

27. The system of claim 15, wherein the amount of digital currency is all of the digital currency associated with the digital wallet.

28. The system of claim 15, wherein the process includes receiving, with the user interface module, a selection from the user indicating the quantity of gold, wherein determining the amount of digital currency is based on the selection of the quantity of gold and the price of gold.

29. A non-transitory computer readable medium having a plurality of computer-executable instructions which, when executed by a processor, perform a method for security for a digital value transaction, the instructions comprising:
a user interface module configured to receive input from a user initiating a transaction to convert digital currency to gold;
a price feed aggregating module configured to gather a plurality of prices of gold each associated with a respective counterparty that deals in gold;
a digital value conversion module configured to determine an amount of digital currency to be converted to a quantity of gold based on at least one of the prices of gold, the user interface module being configured to receive a confirmation from the user to convert the amount of digital currency to the quantity of gold; and
a payment processor module configured to convert the amount of digital currency to the quantity of gold by transferring the amount of digital currency to a selected counterparty.

30. A computing system method for facilitating security for a digital value transaction, comprising:
computing consolidated pricing feeds for a counterparty dealing with gold;
determining a fund required to purchase a quantity of gold from the counterparty;
converting all or a portion of a digital wallet value associated with at least one user to the necessary value;
matching the consolidated pricing feeds that are computed with the necessary value associated with the at least one user for purchasing the quantity of gold from the counterparty;
receiving confirmation from the at least one user to purchase the quantity of gold from the counterparty based on a matching criteria determined after matching the consolidated pricing feeds with the necessary value portion of the user account associated with the at least one user; and
purchasing the quantity of gold from the counterparty after receiving confirmation from the at least one user by transferring the necessary value or less to the counterparty.

31. The method of claim 30, wherein computing the consolidated pricing feeds for the counterparty dealing with gold includes consolidating a bid and ask-spread price that is determined based on a destination vault location of the counterparty.

32. The method of claim 30, wherein the necessary value is in a form of at least one of a virtual currency, bitcoins, social media credits, automated clearing house (ACH), and coupons.

33. The method of claim 30, wherein the matching criteria represents that the necessary value associated with the at least one user exceeds or is equivalent to the consolidated pricing feeds computed for the counterparty.

34. The method of claim 30, further comprising:
consolidating and reconciling net daily conversions of value and settlement of gold purchases;
displaying a status of at least one the digital value transaction that is stored as a record in a memory storage;
eliminating the record after the at least one digital value transaction status is completed;
monitoring at least one the digital value transaction associated with at least one user; and
tracking at least one the digital value transaction associated with the at least one user.

35. The method of claim 34, wherein monitoring of the digital value transaction comprises of checking the gold delivery status to a vault location associated with the at least one user.

36. The method of claim 35, wherein monitoring of the digital value transaction further includes checking various vault locations associated with the at least one user.

37. The method of claim 34, wherein tracking at least one the digital value transaction comprises:
withdrawing a gold delivery from a vault location associated with the at least one user after accepting a request sent by the at least one user to withdraw the gold delivery; and
selling a gold from the vault location associated with the at least one user after accepting a request sent by the at least one user to sell the gold.

38. The method of claim 30, wherein computing consolidated pricing feeds for a counterparty dealing with gold includes computing consolidated pricing feeds for multiple counterparties dealing with gold.

39. A system for facilitating security for a digital value transaction, the system comprising:
at least one processor; and
at least one memory coupled to the at least one processor, the at least one memory having stored therein instructions which, when executed by any set of the one or more processors, perform a process including:
computing consolidated pricing feeds for at least one counterparty dealing with gold;
determining a fund required to purchase a quantity of gold from at least one counterparty;
converting the digital wallet value associated with at least one user to a necessary value;
matching the consolidated pricing feeds that are computed with the necessary value associated with the at least one user for purchasing the quantity of gold from the at least one counterparty;
receiving confirmation from the at least one user to purchase the quantity of gold from the at least one counterparty based on a matching criteria determined after matching the consolidated pricing feeds with the necessary value associated with the at least one user; and
purchasing the quantity of gold from the at least one counterparty after receiving confirmation from the at least one user.

40. The system of claim 39, wherein computing the consolidated pricing feeds for the at least one counterparty dealing with gold includes consolidating a bid and ask-spread price that is determined based on a destination vault location of the at least one counterparty.

41. The system of claim 39, wherein the necessary value is in a form of at least one of a virtual currency, bitcoins, social media credits, automated clearing house (ACH), and coupons.

42. The system of claim 39, wherein the matching criteria represents that the necessary value associated with the at least one user exceeds or is equivalent to the consolidated pricing feeds computed for the at least one counterparty.

43. The system of claim 39, wherein the process further includes:
consolidating and reconciling net daily conversions of value and settlement of gold purchases;
displaying a status of at least one the digital value transaction that is stored as a record in a memory storage;
eliminating the record after the at least one digital value transaction status is completed;
monitoring the at least one digital value transaction associated with at least one user; and
tracking the at least one digital value transaction associated with the at least one user.

44. The system of claim 43, wherein monitoring of the digital value transaction comprises of checking the gold delivery status to a vault location associated with the at least one user.

45. The system of claim 44, wherein monitoring of the digital value transaction further includes checking various vault locations associated with the at least one user.

46. The system of claim 43, wherein tracking at least one the digital value transaction comprises:
withdrawing a gold delivery from a vault location associated with the at least one user after accepting a request sent by the at least one user to withdraw the gold delivery; and
selling a gold from the vault location associated with the at least one user after accepting a request sent by the at least one user to sell the gold.

47. A system for facilitating security for a digital value transaction within a network, the system comprising:
at least one processor; and
at least one memory coupled to the at least one processor, the at least one memory having stored therein instructions which, when executed by any set of the one or more processors, perform a process including:
creating an invoice for a specific digital wallet value equivalent to a quantity of gold to be purchased by at least one user;
generating an invoice identifier for the created invoice, wherein the invoice identifier includes a digital wallet address, a digital wallet value, and a time-period associated with the invoice identifier;
sending the invoice identifier to the at least one user;
receiving a digital signature from the at least one user confirming the invoice identifier using the web interface device;
forwarding the invoice identifier to a server after receiving the digital signature from the at least one user;
publishing the invoice identifier on the network after the server receives the invoice identifier;
confirming the invoice identifier;
completing the digital value transaction after confirming the invoice identifier; and
sending a notification a web interface device of the user indicating that the digital value transaction is completed.

48. The system of claim 47, wherein creating the invoice includes:
computing consolidated pricing feeds for at least one counterparty dealing with gold; and
determining a fund required to purchase the quantity of gold from the at least one counterparty, wherein the fund corresponds to the specific digital wallet value.

49. The system of claim 48, wherein completing the digital value transaction includes purchasing the quantity of gold from the at least one counterparty.

50. The system of claim 49, wherein computing the consolidated pricing feeds for the at least one counterparty dealing with gold includes consolidating a bid and ask-spread price that is determined based on a destination vault location of the at least one counterparty.

51. The system of claim 47, comprising confirming the invoice identifier by performing multiple digital signatures on the invoice identifier.

52. A non-transitory computer readable medium having a plurality of computer-executable instructions which, when executed by a processor, perform a method for security for a digital value transaction, the instructions comprising:
a price feed aggregator module configured to compute consolidated pricing feeds for at least one counterparty dealing with gold;
a digital value conversion module configured to determine a fund required to purchase a quantity of gold from at least one counterparty and to convert the digital wallet value associated with at least one user to a necessary value, and to match the consolidated pricing feeds that are computed with the necessary value associated with the at least one user for purchasing the quantity of gold from the at least one counterparty;
a user interface module configured to receive confirmation from the at least one user to purchase the quantity of gold from the at least one counterparty based on a matching criteria; and
a payment processor module configured to purchase the quantity of gold from the at least one counterparty after receiving confirmation from the at least one user.

53. The non-transitory computer readable medium of claim 52, wherein the price feed aggregating module is configured to receive a plurality of prices for gold from a plurality of counter parties dealing with gold.

54. The non-transitory computer readable medium of claim 52, wherein the user interface module is configured to receive a request from the user to initiate the purchase of the quantity of gold.

55. The non-transitory computer readable medium of claim 52, wherein the user interface module is configured to receive from the user a designation of a selected gold repository.
